(19) United States
(12) Patent Application Publication
(10) Pub. No.: US 2012/0189754 A1
(43) Pub. Date: Jul. 26, 2012

(54) ARRANGEMENT FOR MIXING A FLAVOURING INGREDIENT WITH A LIQUID CARRIER

(75) Inventors: Fabien Ludovic Agon, Le Bouveret (CH); Alexa Perrin, Pully (CH); Alexandre Perentes, Lausanne (CH)

(73) Assignee: NESTEC S.A., Vevey (CH)

(21) Appl. No.: 13/499,124

(22) PCT Filed: Sep. 29, 2010
(86) PCT No.: PCT/EP2010/064416

§ 371 Date: Mar. 29, 2012

(30) Foreign Application Priority Data
Sep. 29, 2009 (EP) 09171608.4
Nov. 3, 2009 (EP) 09174839.2

(51) Int. Cl. A47J 31/00; A23F 5/46; A23C 9/156; A23L 2/56

(52) U.S. Cl. 426/584; 99/287; 426/590; 426/594; 426/519

(57) ABSTRACT

An arrangement (20,120,220,320,420,520,620,720,820,920) to hold a dissolvable and/or dispersible beverage flavouring ingredient in a liquid carrier (105,205,405,505) contained in a device (1,100,200,300,400,500,900) has: a tank (11) for containing this liquid carrier; and an impeller (14,214,214′,514,914) located in this tank for circulating this liquid carrier relative to this ingredient to promote dissolution and/or dispersion of this ingredient in the carrier. Such arrangement has means (26,126,226,326,426,526,626,726,826,926) for securing a self-sustaining body (2,102,202,302,402,502,602,702,802,902) of this ingredient and means (21,121,221,321,421,521,621,721,821,921) for positioning the securing means in this tank so as to secure a position of this self-sustaining body spaced apart from this impeller. The securing means is configured to allow substantially unrestricted flow of this relatively circulating liquid carrier to a main surface (3,103,203,303,403,503,603,703,803,903) of this self-sustaining body.

### FIELD OF THE INVENTION

The present invention relates to an arrangement for the preparation of a beverage with a liquid carrier, e.g. milk and/or water, and a flavouring ingredient, such as a cacao-based ingredient.

### BACKGROUND ART

Various methods are known to prepare chocolate-based beverages. Generally speaking, one may distinguish two types of such chocolate beverages. On the one hand, there are the so-called “ready-to-drink” chocolate beverages which concern the chocolate beverages that are prepared industrially and supplied to the consumer in a directly consumable form. On the other hand, there are the instant chocolate beverages that are supplied to the consumer in the form of particulate chocolate flavouring to be mixed with water and/or milk by the consumer before consumption.

For example, U.S. Pat. No. 6,290,997 and U.S. Pat. No. 6,838,110 disclose instant beverages in the form of coffee-, tea- or cocoa-containing particulate ingredient. The beverage is prepared by a user by mixing such powder with water and/or milk and stirring the mixture for a couple of seconds. In the latter document, it is inter-alia mentioned that, as an inferior embodiment, it is contemplated to supply to the consumer tablets or other solid forms of agglomerate powder ingredient.

U.S. Pat. No. 6,796,705 discloses a mug with a motorised whisk powered by a battery. A first liquid such as milk may be poured into the mug and aerated by activating the motorised whisk. Thereafter, a second liquid can be poured into the aerated milk, the aerated milk floating on top. The second liquid that is poured into the mug may be hot coffee or hot chocolate. The preparation of the second liquid itself is not addressed.

U.S. Pat. No. 6,318,247 relates to an appliance having a vessel with a heating element and a motorised mixing element for preparing hot milk mixed with a flavouring agent such as cocoa or chocolate for producing an amount of froth on top of the beverage in the vessel.

Further frothing tanks having a heater and motorised stirrer are disclosed, for example, in EP1827188 and WO 2008/142154.

U.S. Pat. No. 3,657,994 discloses a brewing cup with a hooked hollow dispenser cylinder having a series of closeable small and spaced appart appertures. The dispenser cylinder is arranged for containing a granulate brew ingredient. During use the brew cup is filled with water, the cylinder's appertures are opened and the cylinder hooked into the cup for brewing the beverage.

U.S. Pat. No. 4,435,084 discloses a cup with a motor driven blade assembly to stir a beverage and a sweetener and/or a creamer.

US 2006/0021989 discloses a coffee cup and a support platform, basket or claw hooked onto the cup's rim for a cookie that is allowed to rest more or less freely against an upper part of the cup's wall.

EP 1 238 608 discloses a beverage applicator having a support member with a beverage material applied thereto such as coffee, milk and/or sugar. A user may hold and immerse the applicator in hot water and manually stir the applicator to form a beverage.

A problem with the preparation of chocolate beverages by mixing cocoa-based powder material with milk or water lies in the incomplete dissolution and/or dispersion of the powder material in the milk. The problem is even worse when chocolate material is used to flavour milk or water as a layer of cocoa fat forms on top of the liquid.

### SUMMARY OF THE INVENTION

It is therefore an object of the invention to alleviate the disadvantages of the prior art by proposing an arrangement for a system for preparing flavoured beverages, in particular chocolate beverages.

This object is generally achieved by an arrangement used in a process for preparing a beverage that comprises: providing a liquid carrier; supplying a flavouring ingredient to the liquid carrier; optionally heating the liquid carrier; and agitating the liquid carrier to promote dissolution and/or dispersion of the flavouring ingredient therein. The flavouring ingredient is supplied in the form of a self-sustaining body to the liquid carrier. The self-sustaining body has at least one surface from which the flavouring ingredient is dissolved and/or dispersed into the liquid carrier. The liquid carrier is agitated in a controlled manner to circulate on said at least one surface so as to achieve a controlled dissolution and/or dispersion of the flavouring ingredient into the liquid carrier.

The self-sustaining body typically has a main surface from which the flavouring ingredient is predominantly dissolved and/or dispersed into the liquid carrier (the “main dissolution and/or dispersion surface”). This surface may be so located in the agitated liquid carrier to be exposed substantially everywhere thereto at a generally uniform relative velocity. Hence, the surface will be generally uniformly worn by dissolution and/or dispersion of the flavouring ingredient therefrom.

The liquid carrier can be water, milk and/or coffee based. The flavouring ingredient may comprise instant coffee, chocolate, cocoa, sugar or honey. The flavouring ingredient can be a delayed (non-instant) dissolution and/or dispersion ingredient, and/or an ingredient selected from at least one of coffee, chocolate, cocoa, sugar and honey, in particular delayed chocolate ingredient.

For example, a self-sustaining body of chocolate (meltable and/or cast cocoa-based solid body) is placed in agitated hot water and/or milk to form hot chocolate in the form of a beverage having an optimal chocolate distribution in the liquid carrier without any precipitation of chocolate or significant phase separation in the beverage. Alternatively, such a body of chocolate may be used in hot or heated coffee to form a mocca coffee. A sweetener such as sugar and/or honey may be incorporated into a milk-based or other liquid carrier in the same manner.

For instance, chocolate, such as white chocolate, milk chocolate or dark chocolate, e.g. chocolate containing cocoa butter or equivalent fat in an amount of more than 15 or 20% in particular in the range of 25 or 30 to 55 or 70%, is not an instant beverage ingredient but a beverage ingredient with a delayed incorporation into the liquid carrier. Chocolate and like ingredients have a relatively slow dissolution and/or dispersion rate in heated liquid and can be quite tricky to incorporate properly into such a liquid. When not incorporated in a controlled manner, chocolate tends to form a layer of fat on top of the liquid with which it is supposed to be mixed. The present invention provides a reliable and simple manner to solve this problem by providing an arrangement for a controlled automatic incorporation via a motorised impeller and usually a heater, both adjusted to the characteristics of chocolate and liquid carrier to optimise the mixing between the carrier and the chocolate ingredient. In such a way a proper emulsification of the chocolate ingredient with the liquid carrier can be achieved, overcoming the prior art problems.

More generally, the term “chocolate” used herein includes in particular dark, milk or white chocolate. The chocolate may comprise sugar, milk derived components and fat and solids from cocoa sources in differing proportions where the total fat content is greater than 25% or 28% by weight of the chocolate. The term chocolate is not limited to materials which may legally be described as chocolate in various countries of the world. In addition, the chocolate may comprise any product or substance having rheological characteristics similar or substantially comparable to those of chocolate having a fat content greater than 25% by weight. Such a product may include chocolate substitutes containing direct cocoa butter replacements, stearines, coconut oil, palm oil, butter or any mixture thereof; chocolate analogues with cocoa butter replaced by a non tempering fat; chocolate products where the sugar has been replaced partially or completely by for example other nutritive carbohydrate sweeteners, or ‘Caramac™’ sold by Nestlé comprising non-cocoa butter fats, sugar and milk.

The self-sustaining body of the ingredient may have a volume that is greater than 2 or 3 cm³, in particular a volume of at least 5 or 10 cm³ such as at least 15 to 20 cm³. Such a self-sustaining body would thus not include one or a plurality of loose powder particles, granules or small chips or fragments of flavouring ingredient.

For example, the liquid will be agitated by a motorised impeller actuated at a constant or a predetermined variable speed adjusted to the characteristics of the carrier liquid and the ingredient body. A controller may be used to control the motorised impeller.

Hence, by applying this process, uncontrolled addition of flavouring ingredient to the carrier liquid causing precipitation of the flavouring ingredient is inhibited. Furthermore, the incorporation of flavouring ingredients with a low miscibility in the liquid carrier, in particular chocolate e.g. cast bodies of chocolate in water, can be achieved satisfactorily, e.g. by full or part emulsification.

More particularly, the invention concerns an arrangement to hold a dissolvable and/or dispersible beverage flavouring ingredient in a liquid carrier, in particular a heated liquid carrier, contained in a device having: a tank for containing this liquid carrier; and an impeller located in this tank for circulating this liquid relative to this ingredient to promote dissolution and/or dispersion of this ingredient in the liquid carrier.

The tank typically has a capacity for preparing one or two cups of beverage, e.g. a capacity in the range of 25 or 30 to 400 ml, in particular 40 to 200 ml, such as 50 to 100 ml. The tank typically has a generally tubular, cylindrical or prismatic, cavity with a base having a diameter of 8 to 15 cm, in particular 9 to 12 cm. The cavity may also be generally frusto-conical with, e.g., a similar capacity or volume.

The tank is typically associated with a means for delivering heat into the liquid carrier in a heat delivery zone, such as a heated tank wall contacting the liquid carrier and/or a hot vapour delivery outlet in the liquid carrier. Details of a tank with a heated bottom are disclosed in EP 1 827 188 and in WO 2008/142154; details of a tank with a steam heating are disclosed in EP 08 163 423.0 and in EP 08 163 427.1. The content of these documents are hereby incorporated by reference. The combination of the principles of these prior art disclosures with the present invention provides the option of aerating or forming foam in the tank, in particular by frothing an appropriate liquid carrier such as milk. The aeration or foaming may be carried out before, during and/or after the dissolution and/or dispersion of the flavouring ingredient into the liquid carrier.

In accordance with the invention, such arrangement has means for securing a self-sustaining body of this ingredient and means for positioning the securing means in this tank so as to secure a position of this self-sustaining body spaced apart from this impeller in this liquid, the securing means being configured to allow substantially unrestricted flow of this relatively circulating liquid carrier to a main surface of this self-sustaining body.

The self-sustaining body is thus secured in a predetermined position in the tank depending only on the configuration of the holding arrangement and its positioning in the tank.

In other words, to enhance controlled dissolution and/or dispersion of the ingredient from the self-sustaining body, a main dissolution and/or dispersion surface of the body is exposed to a flow that is substantially not inhibited by the structure of the arrangement. Hence, this surface is not substantially hidden behind a wall of the arrangement that would shield this surface from the flow of the liquid carrier. Typically, the arrangement holds the self-sustaining body and leaves this main dissolution and/or dispersion surface at least 30 or 40% uncovered, such as at least 50 or 60% uncovered, in particular at least 70, 80 or 90% uncovered.

To reduce the risk of precipitation, the flavouring ingredient can be dissolved and/or dispersed into the liquid carrier at a substantially uniform and sufficiently slow rate from over the entire ingredient dissolution and/or dispersion surface. Hence, the dissolution and/or dispersion surface will be evenly worn by supplying the flavouring ingredient into the liquid carrier and no area of this surface will supply an excessive amount of ingredient leading to precipitation thereof.

The flavouring ingredient may be dissolved and/or dispersed into the liquid carrier from the body's surface at a substantially constant rate over a predominant period of time of the dissolution and/or dispersion. If and when the self-sustaining body is allowed to be entirely mixed with the liquid carrier, the structure of the body may collapse towards the end. However, a convenient tapered shape and/or permanent support structure for the body may inhibit or even prevent such a collapse.

The flow of liquid carrier to which this main dissolution and/or dispersion surface of the self-sustaining body is exposed, is typically generally tangential or parallel to this surface, so that the flow of liquid carrier wears away the body at this surface without being substantially disturbed by the configuration of this body's surface.

The positioning means may be so arranged that the securing means secure a position of this self-sustaining body spaced apart in this liquid carrier from a heater in this tank, in particular a position spaced apart from all surfaces of this tank.

The self-sustaining body is preferably held in the liquid carrier and spaced apart from the heat delivery zone to inhibit heat-generated non-dissolved and non-dispersed supply of flavouring ingredient from the self-sustaining body into the liquid carrier. This can be of particular relevance when a meltable self-sustaining ingredient body like chocolate is used. Indeed, the quality of the beverage, in particular hot chocolate, is increased when the flavouring ingredient is dissolved and/or disposed from the self-sustaining body directly into the liquid carrier rather than when it is allowed to melt and form a paste on a surface of the tank.

In one embodiment, the securing means comprises a holding frame for holding this self-sustaining body. The holding frame has one or more openings for allowing a substantially unrestricted flow of this liquid carrier onto and over this main surface of the self-sustaining body, the frame comprising in particular an insertion opening that is generally arched or generally rectangular for receiving said self-sustaining body with a prismatic shape or tapered shape having a bottom part that is insertable into the frame via the insertion opening.

For instance, the holding frame comprises: a basket for holding this self-sustaining body; and/or one or more suspenders, in particular generally U-shaped or V-shaped suspenders, for supporting a bottom part of this self-sustaining body. The holding frame may have a platform for supporting this self-sustaining body.

The holding frame can have: an open central part for allowing passage of a lower part of this self-sustaining body; and a peripheral support structure for supporting this self-sustaining body that has a shoulder located above this lower part and which is arranged to rest on top of this support structure. In particular, the peripheral support structure is configured to allow the passage of a generally vertical lower part of this self-sustaining body through the open central part and support on the peripheral support structure a generally horizontal extension of this self-sustaining body forming this shoulder. This self-sustaining body is optionally generally T-shaped or inverted L-shaped or semi T-shaped in cross-section.

In further embodiments, the securing means of the arrangement of the invention may comprise at least one of: an anchorage portion arranged to extend into or through this self-sustaining body for securing this body; an element arranged to be force-fitted in this self-sustaining body, such as needle-like, wedge-like, screw-like or nail-like element, or on this self-sustaining body such as a generally claw-like arrangement or inverted V-like arrangement, to suspend this self-sustaining body in the tank; and a hook-like or pincer-like or pliers-like arrangement for gripping this self-sustaining body.

The positioning means can be arranged to suspend the securing means on a top part or rim of the tank. Typically, the securing means have in particular at least one of: a hook-like or pincer-like or pliers-like arrangement and/or a fixing portion with a groove to match this rim; and a lid or part lid to cover at least part of this tank.

The positioning means may comprise at least one foot to support the securing means in the tank, in particular one or more feet resting on a bottom of this tank or a foot on an impeller located on a bottom of this tank.

The positioning means may be integral with a sidewall or a bottom wall of this tank that contains the impeller.

Typically, the securing means are configured to hold this self-sustaining body with its main surface extending generally tangentially to the relatively circulating liquid carrier in this tank.

The invention also relates to a use of a flavouring ingredient, in particular in a manufacturing and/or wrapping process of a self-sustaining body of such ingredient, for preparing a beverage by:
providing a liquid carrier, in particular at least one of water, milk and coffee;
exposing a self-sustaining body of this ingredient to this liquid carrier, this body being in particular held by an arrangement as described above;
optionally heating the liquid carrier; and
agitating the liquid carrier to promote dissolution and/or dispersion of the flavouring ingredient from the self-sustaining body in the liquid carrier.

A vortex may be formed in the liquid carrier by controlled agitation of the liquid carrier, in particular by means of a rotating impeller such as a stirrer associated with a tank containing the liquid carrier, and driving the liquid carrier therein. Examples of such configurations are disclosed in the abovementioned EP 1 827 188, WO 2008/142154, EP 08 163 423.0 and in EP 08 163 427.1 hereby incorporated by way of reference. Hence, the liquid carrier may be driven in a general circular or loop flow. It is also contemplated to subject the liquid carrier to other types of flows, such as a linear flow, in particular in a more or less straight line. The flow of liquid carrier to which the self-sustaining ingredient body is exposed, may be in a loop or open-ended. The flow may be laminar or turbulent.

The self-sustaining body having at least one surface from which the flavouring ingredient is dissolved and/or dispersed into the liquid carrier and the liquid carrier is agitated in a controlled manner to circulate on this at least one surface so as to achieve a controlled dissolution and/or dispersion of the flavouring ingredient into the liquid carrier.

The beverage preparation process may incorporate any feature or combination of features discussed above.

The beverage may be prepared by exposing this self-sustaining body to a liquid carrier circulated in a controlled motion in a tank, in particular in a heated tank and/or under the effect of a rotating impeller. In particular, the beverage may be prepared by exposing this self-sustaining body to a liquid carrier circulated in a tank in a controlled motion, this tank having at least one of: a heater surface contacting and heating this liquid carrier, the self-sustaining body being maintained spaced apart from this heater surface; and a rotating impeller for circulating this liquid carrier, the self-sustaining body being maintained spaced apart from said impeller.

With such a beverage preparation process, the agitation caused by the impeller, typically a rotary stirrer or whisk, can be adjusted to the liquid volume, chocolate quantity and the configuration of the tank to produce a properly dissolved and/or dispersed ingredient in the liquid carrier while preventing the formation of the usual layer of chocolate fat at the top of the liquid. In particular, such a method permits the preparation of traditional undistorted water chocolate drink with a smooth texture.

The velocity of the liquid carrier passing on the dissolution and/or dispersion surface of the self-sustaining body should be aligned to the dissolution and/or dispersion rate.

By providing an off-centred impeller, the liquid carrier that is in the process of being loaded with the flavouring ingredient is better homogenised which increases the total amount of flavouring that can be incorporated by dispersion and/or dissolution into the liquid carrier without precipitation. The mechanism of homogenisation of the agitated liquid carrier by an appropriate geometry and configuration of the tank and impeller, is discussed in greater details in EP 1 827 188 which is hereby integrated by reference.

The support means can be arranged to support this self-sustaining body with a main surface thereof from which the flavouring ingredient is predominantly dissolved and/or dispersed into the liquid carrier, such main surface being arched and extending around the impeller, e.g. form at least an angular portion of a ring-like element.

The self-sustaining body may have a main surface from which the flavouring ingredient is predominantly dissolved and/or dispersed into the liquid carrier. This main surface is so located in the agitated liquid carrier to be exposed substantially everywhere thereto at a generally uniform relative velocity.

### BRIEF DESCRIPTION OF THE DRAWINGS

The invention will now be described with reference to the schematic drawings, wherein:

FIG. 1 shows an arrangement for securing and positioning a self-sustaining ingredient body according to the invention mounted in a beverage preparation device;

FIG. 2 illustrates this securing and positioning arrangement;

FIG. 3 shows the securing and positioning arrangement of FIG. 2 in combination with a self-sustaining ingredient body;

FIG. 4 shows another arrangement for securing and positioning a self-sustaining ingredient body according to the invention mounted in a beverage preparation device;

FIG. 5 shows the securing and positioning arrangement of FIG. 4 in combination with a self-sustaining ingredient body;

FIG. 6 illustrates this self-sustaining ingredient body;

FIG. 7 shows a further arrangement for securing and positioning a self-sustaining ingredient body according to the invention in a beverage preparation device;

FIGS. 8 and 9 illustrate two beverage preparation processes using this beverage preparation device;

FIG. 10 shows yet another arrangement for securing and positioning a self-sustaining ingredient body according to the invention in a beverage preparation device;

FIGS. 11 and 12 illustrate, respectively, this arrangement and this self-sustaining ingredient body;

FIG. 13 shows yet a further arrangement for securing and positioning a self-sustaining ingredient body according to the invention in a beverage preparation device;

FIG. 14 shows this securing and positioning arrangement in combination with a self-sustaining ingredient body, FIG. 15 showing the same securing and positioning arrangement without the self-sustaining body;

FIG. 16 illustrates yet a further arrangement for securing and positioning a self-sustaining ingredient body according to the invention in a beverage preparation device;

FIG. 17 shows this securing and positioning arrangement in combination with a self-sustaining ingredient body, FIG. 18 showing the same securing and positioning arrangement without the self-sustaining body and FIG. 19 showing the self-sustaining body as such;

FIGS. 20 to 22 illustrate further embodiments of arrangements for securing and positioning a self-sustaining ingredient bodies according to the invention;

FIG. 23 illustrates a further arrangement for securing and positioning self-sustaining ingredient bodies according to the invention in a beverage preparation device; and

FIGS. 24 and 25 illustrate, respectively, this arrangement and these self-sustaining ingredient bodies.

### DETAILED DESCRIPTION

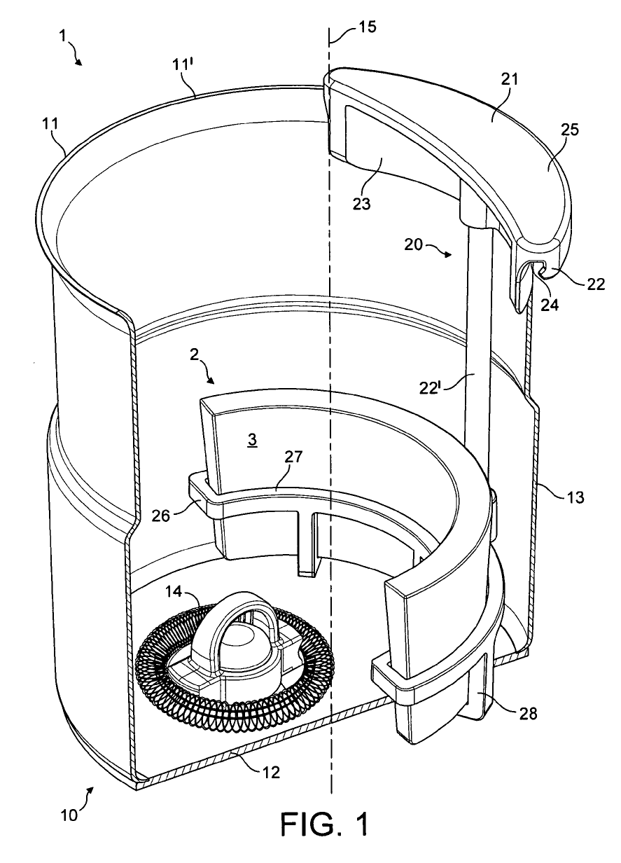

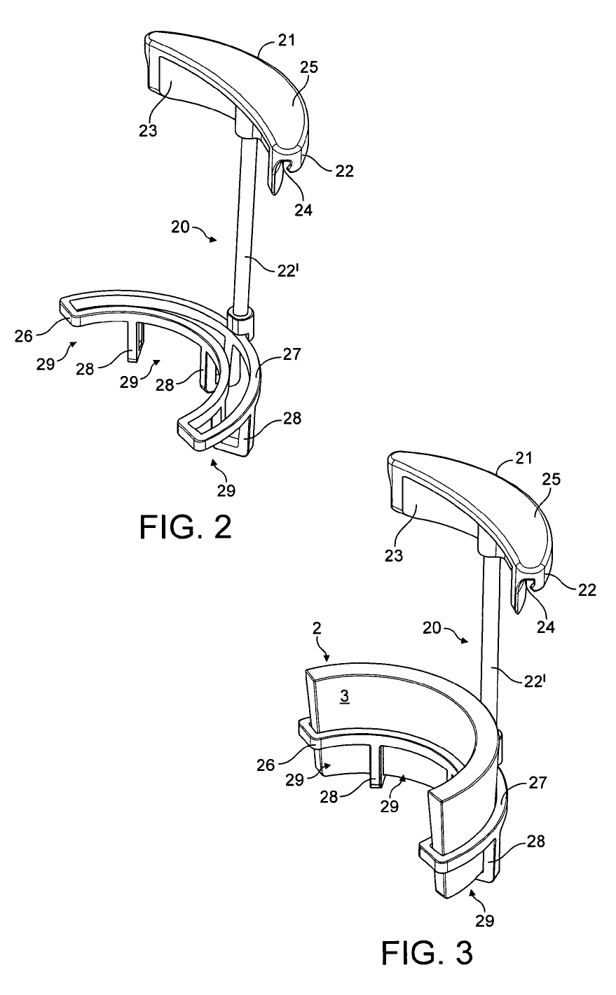

FIG. 1 shows, in perspective view, part of a securing and positioning arrangement 20 according to the invention mounted in a device 1 for carrying out the beverage preparation process. Device 1 has a frothing jug 10 containing arrangement 20 for securing and positioning a self-sustaining body 2 of flavouring ingredient. In FIGS. 2 and 3, arrangement 20 is shown separately, FIG. 3 illustrating body 2 held in arrangement 20.

The exemplary frothing jug 10 shown in FIG. 1 has a generally cylindrical tank 11 for containing a carrier liquid (not shown). Tank 11 has a bottom 12 and sidewall 13. Tank 11 is associated with a resistive heater (not shown), e.g. a thick film heater, applied against the downwardly oriented face of bottom 12 and with an impeller stirrer 14 cooperating with an electric motor (not shown) located underneath bottom 12. Stirrer 14 is driven through bottom 12 by the electric motor via a magnetic coupling arrangement. Further details of jugs having such a structure are disclosed in EP 1 827 188 and WO 2008/142154 that are hereby incorporated by way of reference. As an alternative, the resistive bottom heater may be replaced by a hot vapour heater the details of which can be found in EP 08 163 423.0 or in EP 08 163 427.1 hereby incorporated by way of reference.

Securing and positioning arrangement 20 has a positioning means that comprises a fastening element 21 for properly fixing and positioning arrangement 20 in tank 11. Fastening element 21 has a downwardly projecting outer wall 22 that delimits with a parallel inner wall 23 a groove 24 matching upper rim 11′ of tank 11. Walls 22 and 23 are secured together via fastening platform 25 and are resiliently configured so as to squeeze rim 11′ and safely position arrangement 20 in tank 11.

Platform 25 forms a partial lid covering only a small part of the mounth of tank 11. Hence, the user can monitor and access the inner part of tank 11 during operation. In a variation, such a platform may cover the entire or substantially the entire mouth of the tank to avoid projections of liquid outside the tank. It is possible to make such a platform lid of transparent material so as to give visual access inside the tank during normal operation.

Via a connecting part, e.g. in the form of an upright rod 22′, fastening element 21 holds the securing means of arrangement 20. Securing means include an ingredient basket 26. Basket 26 has a rim part 27 generally shaped as a horizontal half-ring and a series of U-shaped suspenders 28 extending down from mouth 27. Basket 26 may include more or fewer suspenders, say from 1 to 5 or 10 suspenders, in particular 2 to 4 or, as illustrated, 3 suspenders. Rim part 27 and suspenders 28 are arranged to firmly hold self-sustaining ingredient body 2 in tank 11 and delimit large openings 29 for exposing body 2 to the carrier liquid (not shown) through openings 29 during the beverage preparation process. Openings 29 may form at least 80, 90, 95 or 98% of the surface, in particular inner surface, of the basket 26. The outer surface (or rear surface) of basket 26 may also have such openings or be devoid of openings. However, dissolution and/or dispersion may predominantly take place adjacent the inner side of basket 26.

Self-sustaining body 2 has at least one surface, in this embodiment an arched inner surface 3, from which the flavouring ingredient is dissolved and/or dispersed into the liquid carrier during the process. During operating, the liquid carrier is circulated almost unrestrictedly tangentially or parallely over and along a main dissolution and/or dispersion surface 3 of body 2 so as to provide an optimal wear of surface 3 by the circulating liquid carrier for dissolution and/or dispersion.

More generally, self-sustaining body 2 may have a larger surface that is generally aligned to the path of the flow of liquid carrier circulating on the body. Hence, the body's surface that is generally tangential to the flow of liquid, may be maximised to maximise the surface that is preferentially going to be worn by the passage of the liquid carrier. Typically, the body can have a generally plate-like shape with a larger ingredient supply surface positioned generally tangentially to the flow of liquid. If the liquid is circulated in a loop, as in the configuration shown in FIG. 1, body 2 may be curved or arched to follow the flow of the liquid carrier. For example, self-sustaining body 2 is generally plate-shaped and arched, e.g. generally semi-circularly and slightly tapered to generally match the path of the circulating liquid for an optimal dissolution and/or dispersion of the ingredient from body 2.

The motorised stirrer 14 and arrangement 20 are so located in tank 11 that, during use, the liquid carrier is agitated by stirrer 14 in a controlled manner to circulate on the body's dissolution and/or dispersion surface 3 such as to achieve a controlled dissolution and/or dispersion of the flavouring ingredient into said liquid carrier. Stirrer 14 and securing and positioning arrangement 20 are so located or can be so located in tank 11 that body 2 is held at a distance form stirrer 14 during at least substantially the entire dissolving and/or dispersing process. Hence, non-dissolved and non dispersed supply of flavouring ingredient from body 2 is prevented from being supplied into the liquid by mechanical action of stirrer 14 on body 2 which in turn would lead to uncontrolled dissolution and/or dispersion.

Tank 11 shown in FIG. 1 has a general cylindrical shape extending upright about a central axis 15 of revolution of symmetry. Motorised stirrer 14 is located off-axis in tank 11 to cause an improved mixing of the liquid. Securing and positioning arrangement 20 is arranged to support and position body 2 diameterally opposite the impeller and therearound. The securing and positioning arrangement 20 is in particular arranged to support body 2 with its main dissolving and/or dispersing surface 3 that faces stirrer 14.

In this manner, a vortex formed in the carrier liquid by the rotation of stirrer 14 will have a centre of rotation that is off-axis in tank 11 with its taller surface extending over body 2.

In particular, by adjusting the inclination of surface 3 of body 2 to the particular configuration of tank 11 with stirrer 14 and securing and positioning arrangement 20, and to the speed of rotation of stirrer 14, surface 3 can be exposed substantially everywhere thereto at a generally uniform relative velocity of the rotating liquid in tank 11. It is of course also possible to increase the velocity of the carrier liquid on the upper part of body 2, in which case body 2 will be worn not only in its thickness but also in its height by the circulating liquid carrier capturing the dissolving and/or dispersing ingredient as it passes on the body 2.

In a preferred embodiment, self-sustaining body 2 is made of chocolate in particular dark chocolate and the liquid carrier is water and/or milk.

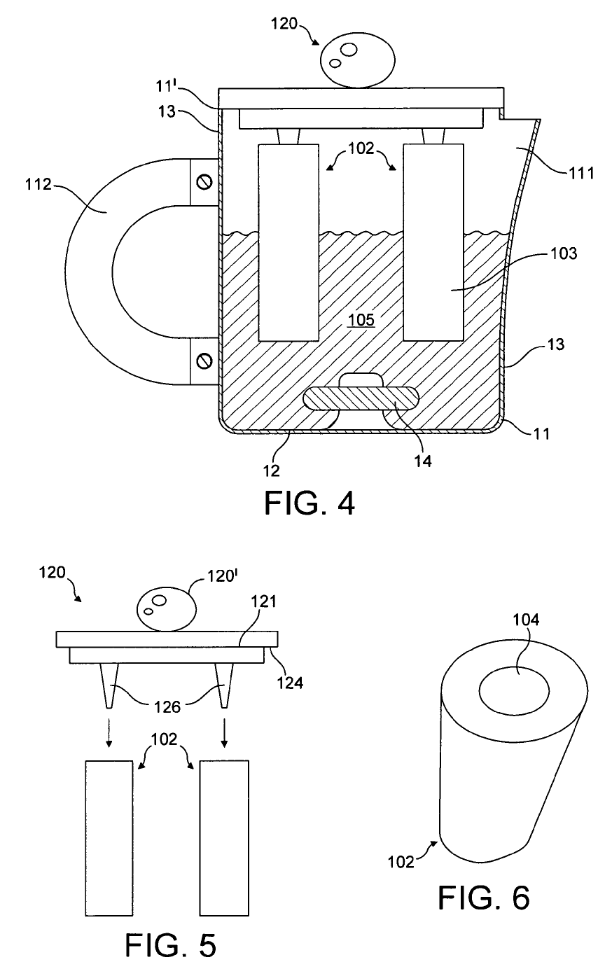

In FIGS. 4 to 25, in which the same numeric references designate the same elements, further embodiments and details of variations of the inventions are illustrated.

FIG. 4 illustrates a beverage preparation device 100 that has a tank 11 with a pouring spout 111 and a handle 112. A securing and positioning arrangement 120 according to the invention is formed as a lid that is mounted on rim 11′ for covering tank 11 and for holding self-sustaining ingredient body 102. Lid 120 and body 102 are shown in greater details in FIGS. 5 and 6.

Lid 120 has a seizure element 120′ for removing lid 120 from tank 11, as well as a positioning means in the form of a covering element 121 with a peripheral shoulder configuration 124 that engages with rim 11′. Moreover, lid 120 has a pair of securing means in the form of two nail-like elements 126 extending downwards from covering element 121. Elements 126 are arranged to be force fitted into corresponding central openings 104 of ingredient bodies 102. Ingredient bodies 102, e.g. made of chocolate, mounted on elements 126 are tubular and dip in a liquid carrier 105, e.g. water and/or milk, contained in tank 11. Ingredient bodies 102 have an outer surface 103 operating as a main dissolving and/or dispersing surface that is immersed into liquid carrier 105.

In a variation, it is of course possible to extend nail-like elements so that the ingredient bodies are fully immersed in liquid carrier during operation. In such a variation, the entire main dissolution/dispersing surface of ingredient body is exposed to the circulating liquid carrier. Moreover, nail-like elements may be substituted by screw-like elements.

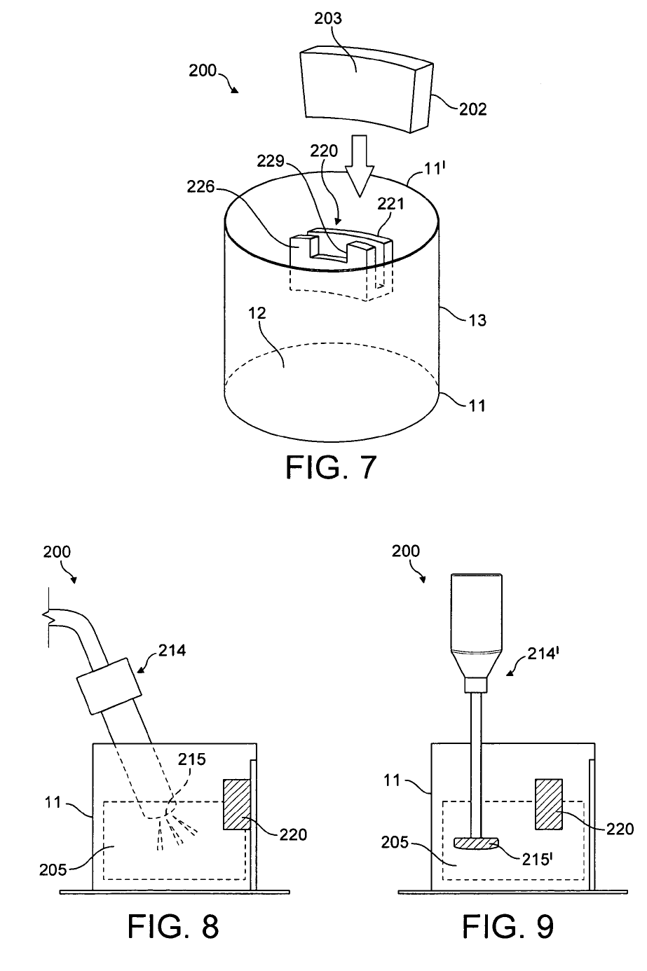

FIG. 7 illustrates a beverage preparation device 200 that has a tank 11. A securing and positioning arrangement 220 according to the invention is formed integrally with the tank sidewall 13. In particular rear part 221 integrally formed with sidewall 13 forms a positioning means of arrangement 220. Arrangement 220 has a holding frame 226 delimiting a cavity for receiving and securing a correspondingly shaped self-sustaining ingredient body 202. Frame 226 has a cut-out or opening 229 for exposing main surface 203 or self-sustaining ingredient body 202 to the circulating liquid carrier 205 during use.

Self-sustaining body 203 has a part cylindrical shape for entering the correspondingly shaped holding frame 226 and for being in line with the flow of liquid carrier 205 in the tank during use.

Operation of device 200 is illustrated in FIGS. 8 and 9. In FIG. 8, device 200 includes a steam pipe 214 with three steam outlet nozzles 215. For example, steam pipe 214 is connected to a steam generation arrangement of a beverage preparation machine, e.g. as disclosed in EP 1 764 014. In this case, steam delivered by steam pipe 214 into liquid carrier 205 acts as an impeller for circulating liquid carrier 205 in tank 11 and as a heater for simultaneously heating liquid carrier 205. Outlet nozzles 215 are held spaced apart from frame 220 with self-sustaining body 202. In FIG. 9, device 200 includes a hand-held stirrer 214′ with a rotating wisk 215′ for circulating liquid carrier 205. In this case, if needed, a separate heating means may be provided to heat liquid carrier 205 in tank 11.

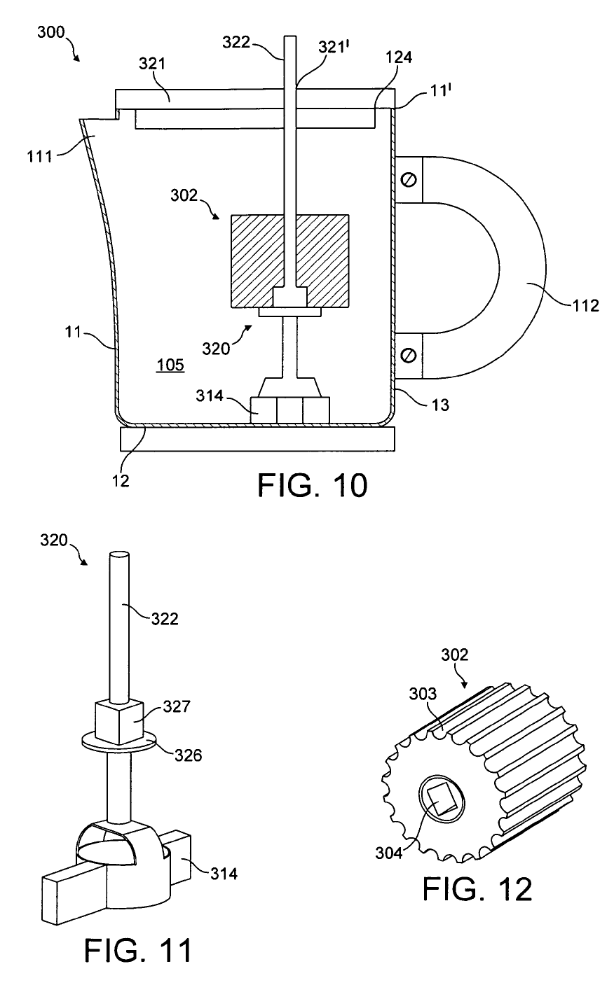

In FIG. 10, tank 11 is covered with a lid 321 having a through-hole 321′ for the passage of a rod 322 connected to whisk 314. A motor (not shown) drives whisk 314 via a magnetic coupling trough bottom 12 of tank 11. Whisk 314 drives rod 322 that is held in free rotation in through-hole 321′. A support plate 326 with a drive element 327 is located on rod 322 and rotatably driven thereby.

The securing means of the invention for self-sustaining body 302 having a dissolving and/or dispersing surface 303, are formed by support plate 326 and drive element 327. Indeed, body 302 has a through-hole 304 for the passage of rod 322. Through-hole 304 has a bottom end with a rectangular cross-section matching the shape of drive element 327. Other shapes, in particular non circular shapes may be contemplated for the cross-section of drive element 327 and bottom end of through-hole 304 for providing a mechanical coupling between these two parts. Whether circular or non-circular, the drive element may secured by force-fitting into the through-hole of the self-sustaining body for providing this coupling function.

The positioning means of the invention are formed by rod 322 connected to whisk 314 and by lid 321 fitted at shoulder 124 on rim 11′ of tank 11.

Securing and positioning arrangement 320 that includes positioning means and the securing means, is shown in greater details in FIG. 11. Self-sustaining ingredient body 302, e.g. made of chocolate, is illustrated separately in FIG. 12.

In this embodiment, self-sustaining body 302 is rotated during use in carrier liquid 105 of tank 11. Hence, circulation of liquid carrier on main surface 303 is at least partly caused by the motion of body 302 in liquid 105.

In a variation it is also possible to use only self-sustaining body mounted on the rotating securing and positioning arrangement to stir the liquid carrier, i.e. without any additional whisk.

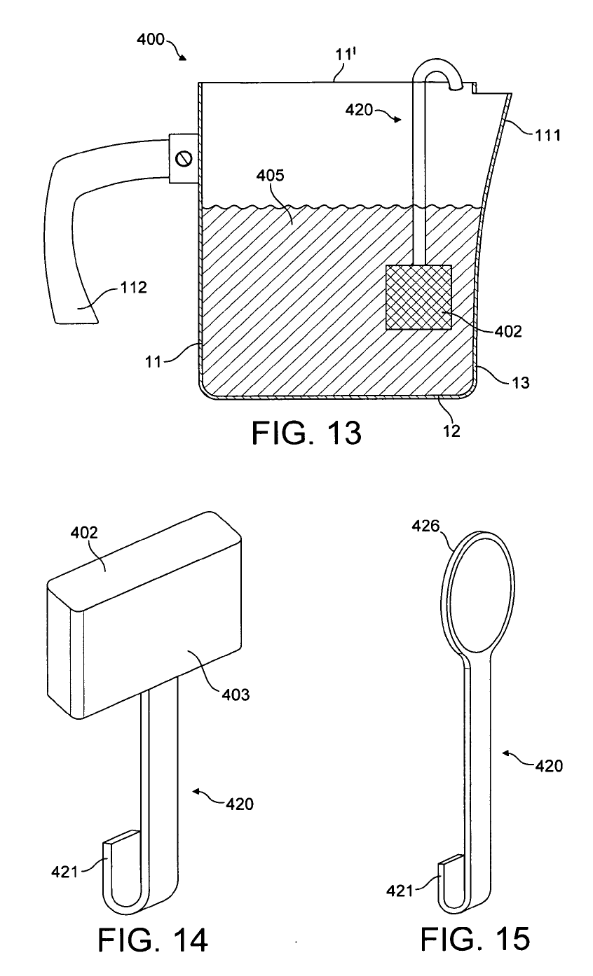

FIGS. 13 to 15 show yet a further embodiment of the invention. In this embodiment, securing and positioning arrangement 420 is made of a spoon part 426, forming the securing means, and a resilient clip end 421, forming the positioning means. Spoon part 426 secures by anchoring a self-sustaining ingredient body 402 having a dissolution and/or dispersion surface 403 located in a circulating liquid carrier 405 during use. Self-sustaining body 402 may be formed by casting the flavouring ingredient on spoon part 426. For example, the ingredient is or contains meltable chocolate.

Resilient clip end 421 is configured to be fixed on rim 11′ for positioning arrangement 420 in tank 11 so that self-sustaining body secured to spoon part 426 is properly positioned and secured in liquid carrier 405. As described above, liquid carrier 405 may be driven by a whisk or by a steam jet (not shown in FIG. 13) in tank 11 to promote dissolution and/or dispersion of the flavouring ingredient from main surface 403 of body 402. When body 402 is fully dissolved and/or dispersed in liquid carrier 405, arrangement 420 is freed from this ingredient body and can be used like a spoon by the user.

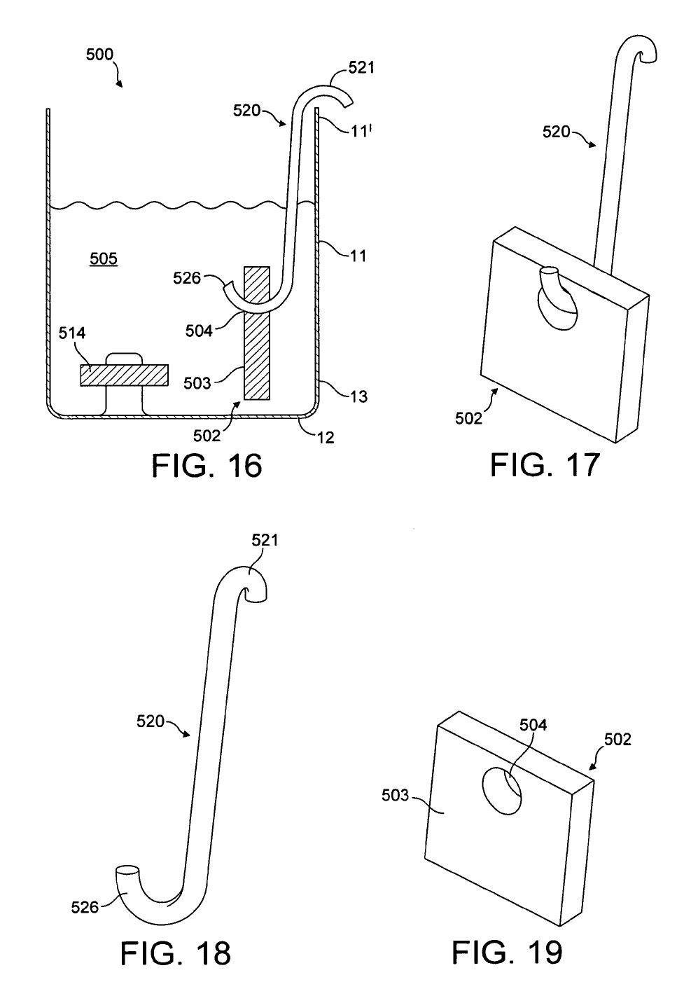

FIGS. 16 to 18 disclose a further embodiment of the invention in which positioning and securing arrangement 520 has a hook-like end 526 for securing a self-sustaining ingredient body 502 with a through-opening 504 for the passage of end 526. Furthermore, arrangement 520 has a resilient clip end 521 for positioning safely arrangement 520 on rim 11′ of tank so that self-sustaining ingredient body 502 is properly positioned and secured in liquid 505 which circulates on main dissolution and/or dispersion surface 503 of body 502 under the effect of an impeller, e.g. rotating whisk 514. In FIG. 16, resilient clip end 521 is shown stretched open corresponding to its configuration when arrangement 520 is mounted or removed from tank 11.

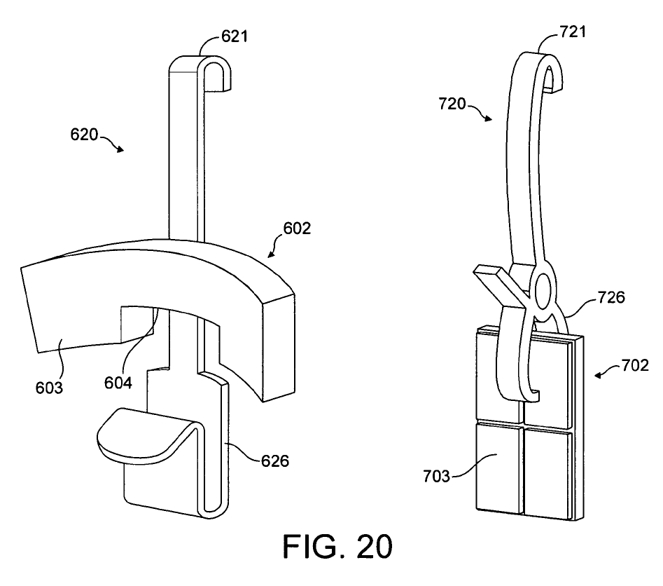

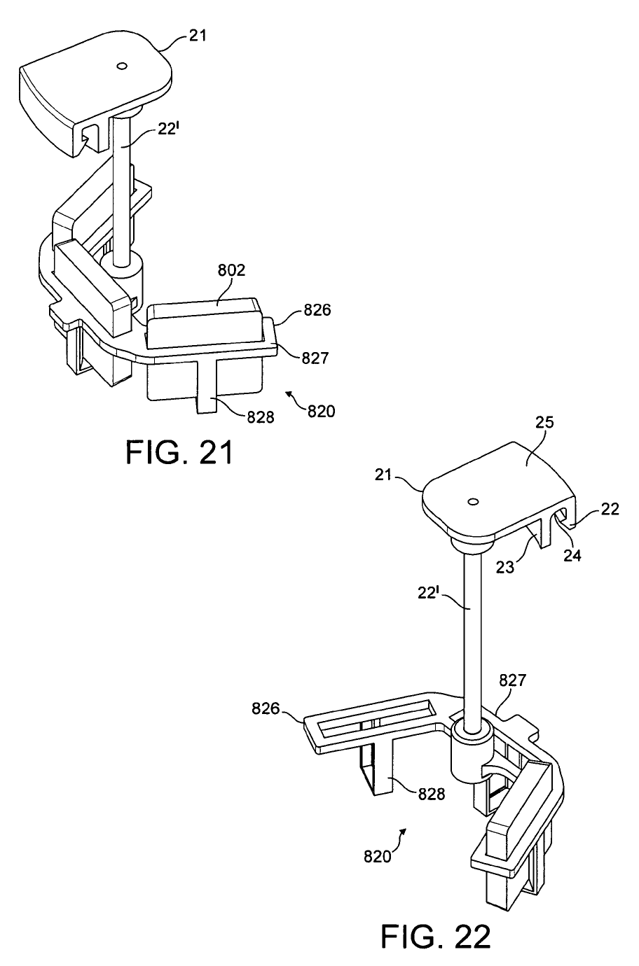

FIGS. 20 to 22 show further variations of positioning and securing arrangements 620,720,820 according to the invention. These arrangements may be used in combination with tanks 11 shown is FIGS. 1, 7 to 9, 13 and 16. Arrangements 620,720 shown in FIGS. 20 and 21 have positioning means 621,721 of the same type as illustrated in FIG. 15 and indicated by reference 421. Positioning means 21 shown in FIGS. 21 and 22 generally correspond to the one shown in FIGS. 1 to 3.

Arrangement 620 has a generally u-shaped securing means 626 for receiving a self-sustaining ingredient body 602 that has a generally inverted u-shape. Body 602 is formed as a section of a tubular wall with a cut-out 604 that cooperates with and is secured in generally u-shaped support member 626.

Support member 626 may be resilient so as to squeeze body 602 to increase the securing action on body 602. Moreover, body 602 has a main dissolution and/or dispersion surface 603 which is predominantly exposed to the circulating liquid carrier during use.

Arrangement 720 has a securing means 726 formed of a resilient assembly, e.g. like pliers or a clothes peg. Self-sustaining ingredient body 702 with main surface 703 is shown as a section of a tablet of chocolate.

Arrangement 820 shown in FIGS. 21 and 22 has a securing means formed of a triple basket 826 having a rim part 827 and suspenders 828 that form three seats for receiving three separate pieces of chocolate 802, for instance broken off from a bar of chocolate. The seats are juxtaposed generally in a half-circle to fit the cavity of a tank 11 that contains the carrier liquid, as described above.

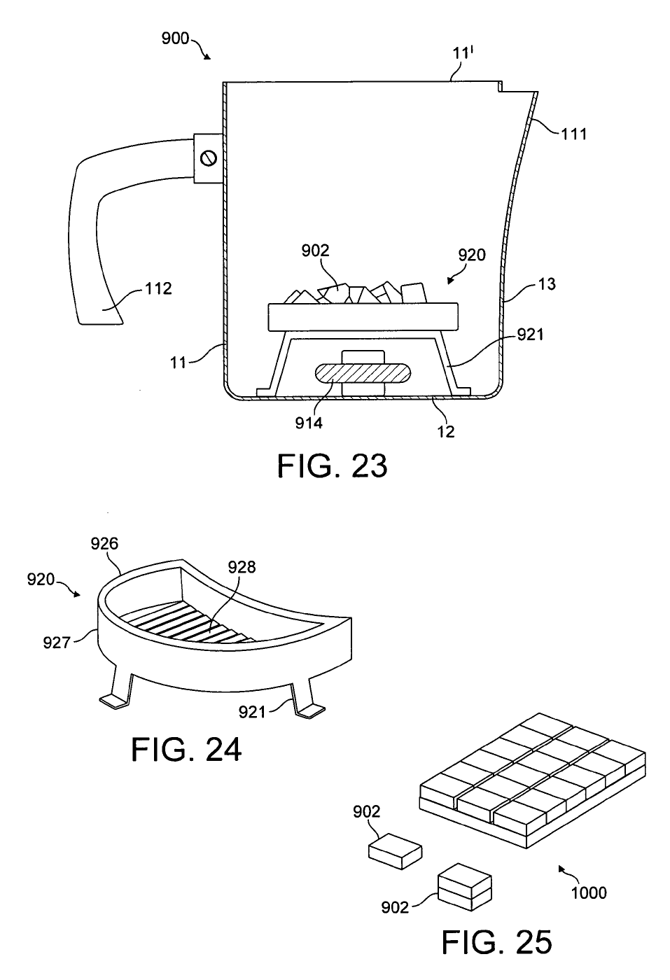

FIGS. 23 to 25 illustrate a further embodiment of the invention in which beverage preparation device 900 has a tank 11 with a whisk 914 as shown in FIGS. 1 and 16 and a positioning and securing arrangement 920 that rests on bottom 12 of tank 11.

Arrangement 920 has a securing basket 926 for holding pieces of chocolate 902 forming self-sustaining ingredient bodies. Basket 926 may have a bottom grid 928 for allowing the passage of the liquid carrier and/or a sidewall 927 in the shape of a grid (not shown). Pieces of chocolate 902 may have been broken off from a tablet of chocolate 1000 as illustrated in FIG. 25.

Furthermore, arrangement 920 has positioning feet 921 for positioning securing basket 926 on bottom 12 of tank 11. Positioning feet 921 may merely rest on bottom 12 of tank 11 or may be squeezed between walls 13 of tank 11 or may be secured by a mechanical connection in the tank. As shown in FIG. 23, arrangement 920 is so positioned by feet 921 in tank 11 to secure self-sustaining bodies 920 over whisk 914.

1. A holding arrangement for holding a dissolvable and/or dispersible beverage flavoring ingredient in a liquid carrier, that is contained in a device, the device comprising:
a tank for containing the liquid carrier;
an impeller located in the tank for circulating the liquid carrier relative to the ingredient to promote dissolution and dispersion of the ingredient in the carrier,
the holding arrangement has a securing member for securing a self-sustaining body of the ingredient and a positioning member for positioning the securing member in the tank so as to:
secure a position of the self-sustaining body spaced apart from the impeller in the liquid carrier; and
allow substantially unrestricted flow of the relatively circulating liquid carrier to a main surface of the self-sustaining body.

2. The arrangement of claim 1, wherein the positioning member is so arranged that the securing member secures a position of the self-sustaining body spaced apart in the liquid carrier from a heater in the tank, in particular a position spaced apart from all surfaces of the tank.

3. The arrangement of claim 1, wherein the securing member comprises a holding frame for holding the self-sustaining body, the holding frame having one or more openings for allowing a substantially unrestricted flow of the liquid carrier onto and over the main surface of the self-sustaining body, the frame comprising an insertion opening for receiving the self-sustaining body having a bottom part that is insertable into the frame via the insertion opening.

4. The arrangement of claim 3, wherein the holding frame comprises:
a basket for holding the self-sustaining body.

5. The arrangement of claim 3, wherein the holding frame comprises a platform for supporting the self-sustaining body.

6. The arrangement of claim 3, wherein the holding frame has:
an open central part for allowing passage of a lower part of the self-sustaining body; and
a peripheral support structure for supporting the self-sustaining body that has a shoulder located above said lower part and arranged to rest on top of the support structure.

7. The arrangement of claim 1, wherein the securing member comprises at least one structure selected from the group consisting of:
an anchorage portion positioned to extend into or through the self-sustaining body for securing the body;
an element arranged to be force-fitted in the self-sustaining body; and
a structure for gripping the self-sustaining body.

8. The arrangement of claim 1, wherein the positioning member is arranged to suspend the securing member on a top part or rim of the tank, the securing member having at least one structure selected from the group consisting of: a hook-like, pincer-like, pliers-like arrangement, a fixing portion with a groove to match the rim; and a lid to cover at least part of the tank.

9. The arrangement of claim 1, wherein the positioning member comprises at least one foot to support the securing member in the tank.

10. The arrangement of claim 1, wherein the positioning member is integral with a wall of the tank that contains the impeller.

11. The arrangement of claim 1, wherein the securing member is configured to hold the self-sustaining body with its main surface extending generally tangentially to the relatively circulating liquid carrier in the tank.

12. A method of using a flavoring ingredient for preparing a beverage by:
providing a liquid carrier;
exposing a self-sustaining body of the ingredient to the liquid carrier, the body being held by an arrangement for holding the flavoring ingredient, the device comprising: a tank for containing the liquid carrier; an impeller located in the tank for circulating the liquid carrier relative to the ingredient to promote dissolution and dispersion of the ingredient in the carrier, the holding arrangement has a securing member for securing a self-sustaining body of the ingredient and a positioning member for positioning the securing member in the tank so as to: secure a position of the self-sustaining body spaced apart from the impeller in the liquid carrier; and allow substantially unrestricted flow of the relatively circulating liquid carrier to a main surface of the self-sustaining body; and
agitating the liquid carrier to promote dissolution and/or dispersion of the flavoring ingredient from the self-sustaining body in the liquid carrier,
of the flavoring ingredient into the liquid carrier.

13. Method according to claim 12, wherein the flavoring ingredient is selected from the group consisting of a delayed dissolution ingredient and a dispersion ingredient.

14. Method according to claim 12, for preparing a beverage by exposing the self-sustaining body to a liquid carrier circulated in a tank.

15. Method according to claim 14, for preparing a beverage by exposing the self-sustaining body to a liquid carrier circulated in a tank in a controlled motion, the tank having at least one structure selected from the group consisting of:
a heater surface contacting and heating the liquid carrier, the self-sustaining body being maintained spaced apart from the heater surface; and
a rotating impeller for circulating the liquid carrier, the self-sustaining body being maintained spaced apart from the impeller.

16. The arrangement of claim 3, wherein the holding frame comprises one or more suspenders.

17. The arrangement of claim 1, wherein the peripheral support structure is designed to allow passage of a generally vertical lower part of the self-sustaining body through the open central part and support on the peripheral support structure a generally horizontal extension of the self-sustaining body forming.

18. Method of claim 17, wherein the liquid carrier is selected from the group consisting of water, milk and coffee.

19. Method of claim 12 comprising heating the liquid carrier.

20. Method of claim 12, wherein the self-sustaining body has at least one surface from which the flavoring ingredient is dissolved and/or dispersed into the liquid carrier and the liquid carrier being agitated in a controlled manner to circulate on the at least one surface so as to achieve a controlled dissolution and/or dispersion of the flavoring ingredient into the liquid carrier.

21. Method of claim 12, wherein the flavoring ingredient is selected from the group consisting of coffee, chocolate, cocoa, sugar and honey.
